(19) United States
(12) Patent Application Publication
(10) Pub. No.: US 2024/0170889 A1
(43) Pub. Date: May 23, 2024

(54) PLUG CONNECTOR WITH COVER AND AUTOMATIC POSITIONING

(71) Applicant: HIRSCHMANN AUTOMOTIVE GMBH, Rankweil/Brederis (AT)

(72) Inventor: Simon EILER, Rabhweuk (AT)

(21) Appl. No.: 18/282,525

(22) PCT Filed: May 19, 2022
(86) PCT No.: PCT/EP2022/063628

§ 371 Date: Sep. 16, 2023

(30) Foreign Application Priority Data
May 20, 2021 (DE) 10 2021 113 184.7

(51) Int. Cl. H01R 13/629

(52) U.S. Cl. CPC H01R 13/62933

(57) ABSTRACT

Plug connection with a plug connector (2) and a mating plug connector (3), which form a male connector and a female connector and can be latched with one another, at least indirectly, characterized by a housing (1) in which a plug connector (2) can be inserted and fixed and in which a space for receiving a mating plug connector (3) is provided, and by a housing cover (4) which is pivotably mounted on the housing (1) and has locking and unlocking elements which are spaced apart from the pivot bearing and which can be brought into contact with supporting elements on the mating plug connector (3).

The invention relates to a plug connector with a first connector element and a second connector element, one of which is male and the other female.

The object of the invention is therefore to improve a plug connector of above-described type with regard to its handling.

According to the invention, the object is achieved by a housing in which a first connector element can be inserted and fixed and that has a space for receiving a second connector element that is pivotable on the housing by a cover that has locking and unlocking elements spaced apart from the pivot bearing and that can be contacted with support elements on the second connector element. The locking and unlocking elements can be stops and the supporting elements can be pins.

It should be pointed out that the locking and unlocking elements on the second connector element and the support elements can alternatively or additionally be on the cover. As a result of this configuration, the cover can effect the contacting and fixing of the connector elements to one another. As will be explained below, the contacting can also be carried out by a service person, the cover then effecting the fixing and locking of the connector elements to one another

In a further embodiment of the invention, it is proposed that the locking stops on the cover engage behind the pins after insertion of the plug connector into the housing and partial pivoting of the cover, and that the locking stops engage behind the pins after insertion of the plug connector into the housing and partial pivoting of the cover. Contacting and locking of the plug connector takes place by closing the cover. When the cover is opened, the unlocking stops on the cover contact the pins on the second connector element, and the decoupling of the plug connector is effected by further opening of the cover.

Furthermore, it is proposed that the unlocking stops are made laterally resiliently on the cover and have feed bevels whose maximum transverse spacing corresponds at least to the end spacing of the pins on the second connector element, making contact with the first connector element by an operator and then nevertheless easily closing the cover and securing the connector elements against one another by the locking stops.

As a result of the feed bevels, the unlocking stops are guided laterally to the end faces of the pins and can pass the pins by lateral, elastic yielding without the cover being blocked. After passing the pins, the unlocking stops spring back and, when the cover is opened, can contact the pins again and make contact with the plug connectors.

Furthermore, it is proposed that the cable of the second connector element extends at an angle to the longitudinal direction of the plug and, after contacting, leaves the housing or the cover laterally. For this purpose, the cover has a cutout for the cable.

Furthermore, the cover has, at its end, projections that, after contacting the second connector element, engage behind the connector housing thereof, so that additional fixing of the second connector element to the housing takes place via the cover.

In order to ensure fixing of the cover to the housing, it is proposed that the cover be designed to be latchable to the housing.

In a further embodiment of the invention, reference is made to the drawings, in which embodiments of the invention are illustrated in a simplified manner. Therein:

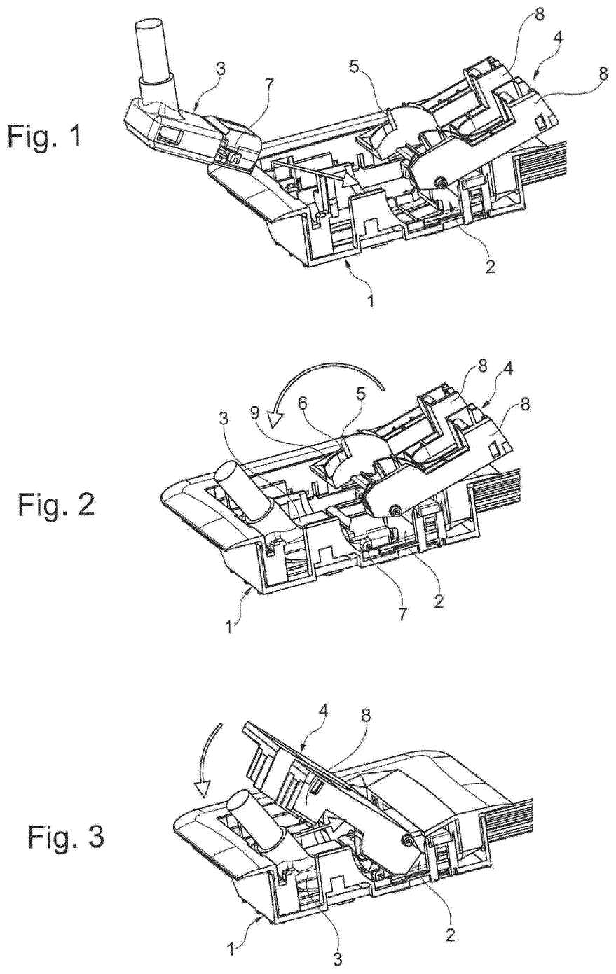

FIG. 1 is a perspective view of a plug connector with housing, cover, mounted first connector element and a second connector element prepared for contacting,

FIGS. 2 to 4 show assembly steps from the insertion of the second connector element into the housing as well as partial and complete closing of the cover,

FIG. 5 shows a plug connector with a housing according to FIG. 1, in which the second connector element has already been coupled with the first connector element,

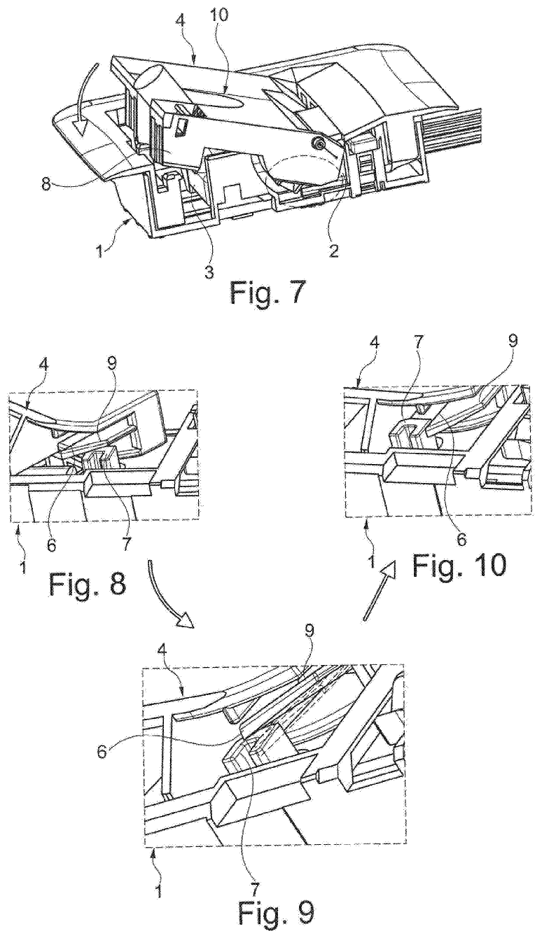

FIGS. 6 and 7 show the closing process of the cover of a plug connector according to FIG. 5; and

FIGS. 8 to 10 are detail views on an enlarged scale with showing the lateral resilience of the unlocking stops.

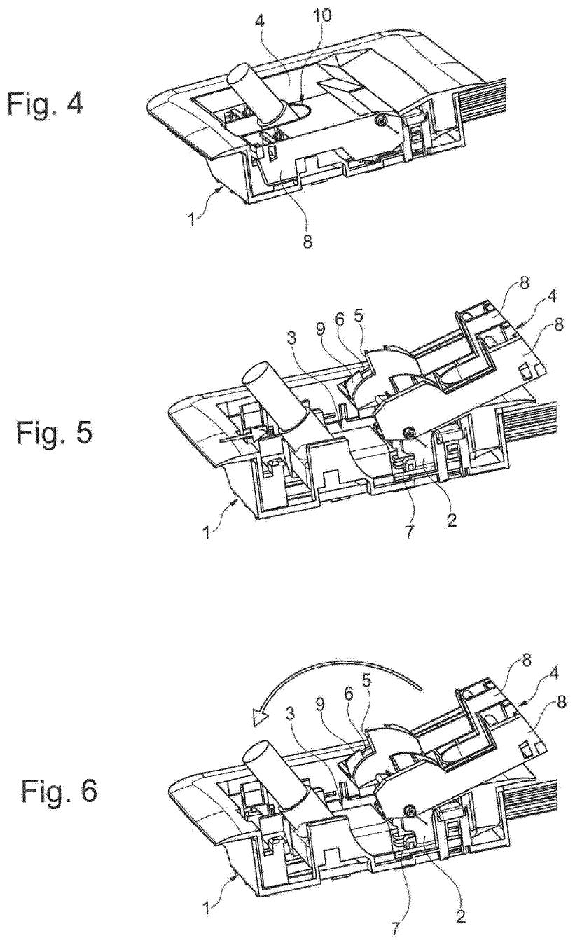

In FIGS. 1 to 10, as far as shown in detail, reference numeral 1 designates a housing in which a first connector element 2 is fixed. Adjacent the first connector element 2, a space is provided in the housing 1 in which can fit a second connector element 3 here a pin plug. A cover shown at 4 is pivotally mounted on the upper side of the housing 1. Locking stops 5 and unlocking stops 8 are provided on the cover 4 at a spacing from the pivot of the cover 4. Pins 7, designed in conjunction with the position of the locking stops 5 and unlocking stops 6 and of the second connector element 3, are provided laterally on the second connector element 3, so that, when the cover 4 is closed (see FIGS. 2 and 3), the unlocking stops 6 pass the pins 7 and the locking stops 5 come into engagement with the pins 7 and the second connector element 3 couples with the first connector element 2, so that a contacting and locking of the plug connector according to FIG. 4 takes place.

The cover 4 is provided in the region of the cover end with projections 8 that, after complete closing of the cover 4, engage behind the housing of the second connector element 3 and effect an additional locking of the second connector element 3. Alternatively, the projections do not serve for additional locking, but rather ensure that the plug-in system is fully plugged together.

As can be seen from FIGS. 5 to 10, the second connector element 3 according to FIG. 5 can also be contacted with the first connector element 2 by an operator without exercising inventive skill. Without the measures described below, the unlocking stops 6 would become jammed against the pins 7, so that closure of the cover 4 necessary for its proper functioning would not be possible. In order to avoid this, the unlocking stops 6, as shown in FIGS. 8 to 10, have feed bevels 9 whose transverse spacing corresponds at least to the end spacing of the pins 7. As a result, the feed bevels 9 can pass the pins 7 and, when the cover 4 is further closed, elastically bend the unlocking stops 6 laterally apart, so that they can pass the pins 7. The unlocking attachment 6, as shown in FIG. 10, is then positioned behind the pin 7 and ready for re-unlocking the second connector element 3 from the first connector element 2.

### LIST OF REFERENCE NUMERAL

1 Housing
2 Second connector element
3 First connector element
4 Cover
5 Locking stops
6 Unlocking stops
7 Pin
8 Projections
9 Lead bevel
10 Recess

1. A plug connector comprising:
a first connector element;
a second connector element, one of the elements being male and the other female;
a housing fixedly holding the first connector element and forming a space for receiving the second connector element; and
a cover pivotably mounted on the housing and having locking and unlocking elements spaced apart from the pivot 10 bearing and that can be contacted with support elements on the second connector element.

2. The plug connector according to claim 1, wherein the locking and unlocking elements are stops and the locking and unlocking elements are pins.

3. The plug connector according to claim 2, wherein the locking stops on the cover and the pins are formed and arranged in such a way that, after insertion of the second connector element into the housing and pivoting of the cover, the locking stops engage behind the pins on the second connector element and closing the cover couples and locks together and the connector elements.

4. The plug connector according to claim 2, wherein the unlocking stops on the cover and the pins are constructed and arranged such that, when the cover is opened, the unlocking stops contact the pins on the second connector element and coupling and disconnecting of the plug connectors takes place by further opening of the cover.

5. The plug connector according to claim 2, wherein the unlocking stops are formed laterally resiliently on the cover and have feed bevels whose maximum transverse spacing corresponds at least to an end spacing of the pins on the second connector element.

6. The plug connector according to claim 1, wherein a cable of the second connector element extends obliquely to a longitudinal direction thereof.

7. The plug connector according to claim 6, wherein the cover has a cutout for the cable.

8. The plug connector according to claim 1, wherein the cover has projections that engage behind the connector housing of the second connector element after same has been closed.

9. The plug connector according to claim 1, wherein the cover is latchable to the housing.
